(19) United States
(12) Patent Application Publication
(10) Pub. No.: US 2021/0233103 A1
(43) Pub. Date: Jul. 29, 2021

(54) SALES PROMOTION SYSTEM AND SALES PROMOTION METHOD

(71) Applicant: PANASONIC INTELLECTUAL PROPERTY MANAGEMENT CO., LTD., Osaka (JP)

(72) Inventor: Keisuke SUETSUGI, Tokyo (JP)

(73) Assignee: PANASONIC INTELLECTUAL PROPERTY MANAGEMENT CO., LTD., Osaka (JP)

(21) Appl. No.: 17/257,403

(22) PCT Filed: Jun. 24, 2019
(86) PCT No.: PCT/JP2019/025013

§ 371 Date: Dec. 31, 2020

(30) Foreign Application Priority Data
Jul. 5, 2018 (JP) 2018-128020

(51) Int. Cl. G06Q 30/02; G06Q 30/06

(52) U.S. Cl. CPC G06Q 30/0224; G06Q 30/0631; G06Q 30/0255; G06Q 30/0201

(57) ABSTRACT

A sales promotion system includes a cyber action management server configured to collect cyber action history information about persons' past actions in websites; a real action management server configured to collect real action history information about persons' past actions in a physical store; an integrated action management server configured to integrate the cyber action history information and the real action history information to generate integrated action history information for each person, and analyze the integrated action history information to generate purchase prediction information about a product which a target customer is predicted to purchase; and a sales promotion information delivery server configured to deliver, based on the purchase prediction information, sales promotion information for the target customer to at least one for a terminal for the target customer and a terminal for a staff member of the physical store.

### TECHNICAL FIELD

The present invention relates to a sales promotion system and a sales promotion method for generating and delivering sales promotion information to encourage customers to purchase.

### BACKGROUND ART

In recent years, an increased number of consumers use virtual stores (online shops) on e-commerce (EC) websites on the Internet. Many consumers, who use such virtual stores, tend to come to physical stores only to check real products, and purchase the products not at the physical stores, but through virtual stores. In other words, a problem is that consumers tend not to purchase goods at physical stores even when they come to those stores. Thus, it is desired to implement effective on site measures which drive customers to come to physical stores in order to purchase, thereby promoting sales of products at the physical stores.

Known such technologies for promoting sales of products at physical stores include a method for issuing customer-specific coupons for respective customers based on information on purchase history at online virtual stores and information on purchase history at physical stores (Patent Document D1). Another such technology is a system for issuing customer-specific coupons which are predicted to be effective for respective customers based on information on purchase history at physical stores, where the information on purchase history for each customer includes a latest store visit date, store visit frequency, and a cumulative amount of purchase payments made (Patent Document 2).

### PRIOR ART DOCUMENT(S)

### Patent Document(S)

Patent Document 1: JP2003-22393A

Patent Document 2: JP2003-30749A

### SUMMARY OF THE INVENTION

### Task to be Accomplished by the Invention

In the above-described prior art, methods or systems are configured to issue coupons which are usable at physical stores, thereby promoting sales of products at those physical stores. However, the methods or systems of the prior art, which utilize, in determining customer specific coupons to be issued, information only on purchase history at online virtual stores and that at physical stores, cannot precisely determine products which a customer is predicted to purchase. This has caused a problem of issuance of irrelevant coupons which would not be used by the customer, resulting in failure to provide adequately successful sales promotion at physical stores.

The present invention has been made in view of the problem of the prior art, and a primary object of the present invention is to provide a sales promotion system and a sales promotion method which makes it possible to precisely determine a product which a target customer is predicted to purchase, and implement on site measures to encourage the customer to purchase the product, thereby promoting sales of products at a physical store.

### Means to Accomplish the Task

An aspect of the present invention provides a sales promotion system for generating and delivering sales promotion information to encourage customers to purchase, comprising: a management server; and a delivery server; wherein the management server is configured to: acquire cyber action history information about persons' past actions on Internet; acquire real action history information about persons' past actions in a physical store; integrate the cyber action history information and the real action history information to generate integrated action history information for each person; and perform an analyzing operation on the integrated action history information to thereby generate purchase prediction information about a product which a target customer is predicted to purchase, and wherein the delivery server is configured to: deliver, based on the purchase prediction information, the sales promotion information for the target customer to at least one of a terminal for the target customer and a terminal for a staff member of the physical store.

Another aspect of the present invention provides a sales promotion method for causing an information processing system to perform operations to generate and deliver sales promotion information to encourage customers to purchase, the operations comprising: acquiring cyber action history information about persons' past actions on Internet; acquiring real action history information about persons' past actions in a physical store; integrating the cyber action history information and the real action history information to generate integrated action history information for each person; performing an analyzing operation on the integrated action history information to thereby generate purchase prediction information about a product which a target customer is predicted to purchase; and delivering, based on the purchase prediction information, the sales promotion information for the target customer to at least one of a terminal for the target customer and a terminal for a staff member of the physical store.

### Effect of the Invention

According to the present invention, cyber action history information about persons' past actions on Internet and real action history information about persons' real past actions in a physical store are integrated to generate integrated action history information for each person, and the so generated integrated action history information is analyzed. To analyze such integrated action history information enables precise determination of a product which a target customer is predicted to purchase; that is, a product which the customer is highly motivated to purchase at present. As a result, it becomes possible to effectively encourage customers to purchase and drive the customers to make purchase decisions, thereby promoting sales of products at physical stores.

### BRIEF DESCRIPTION OF THE DRAWINGS

FIG. 1 is a diagram showing a general configuration of a sales promotion system according to an embodiment of the present invention;

FIG. 2 is an explanatory diagram showing an outline of the sales promotion system;

FIG. 3 is a functional block diagram showing a cyber action management server 1;

FIG. 4 is an explanatory diagram showing an example of records registered in a cyber action history database 32;

FIG. 5 is a functional block diagram showing a real action management server 11, an image analysis server 12, a purchase management server 13, and a touchpoint system management server 14;

FIG. 6 is an explanatory diagram showing examples of records registered in a face registration database 45, a customer purchase history database 52, a user management database 63, and a touchpoint history database 64;

FIG. 7 is an explanatory diagram showing examples of records registered in a real action history database 72 and a customer information database 73;

FIG. 8 is a functional block diagram showing an integrated action management server 21 and a sales promotion information delivery server 22;

FIG. 9 is an explanatory diagram showing examples of records registered in an integrated action history database 85 and a sales promotion information database 96; and

FIG. 10 is an explanatory diagram showing an outline of operations performed by an action predictor 83 of the integrated action management server 21.

### DESCRIPTION OF THE PREFERRED EMBODIMENT(S)

A first aspect of the present invention made to achieve the above-described object is a sales promotion system for generating and delivering sales promotion information to encourage customers to purchase, comprising: a management server; and a delivery server; wherein the management server is configured to: acquire cyber action history information about persons' past actions on Internet; acquire real action history information about persons' past actions in a physical store; integrate the cyber action history information and the real action history information to generate integrated action history information for each person; and perform an analyzing operation on the integrated action history information to thereby generate purchase prediction information about a product which a target customer is predicted to purchase, and wherein the delivery server is configured to: deliver, based on the purchase prediction information, the sales promotion information for the target customer to at least one of a terminal for the target customer and a terminal for a staff member of the physical store.

In this configuration, cyber action history information about persons' past actions on Internet and real action history information about persons' real past actions in a physical store are integrated to generate integrated action history information for each person, and the so generated integrated action history information is analyzed. To analyze such integrated action history information enables precise determination of a product which a target customer is predicted to purchase; that is, a product which the customer is highly motivated to purchase at present. As a result, it becomes possible to effectively encourage customers to purchase and drive the customers to make purchase decisions, thereby promoting sales of products at physical stores.

A second aspect of the present invention is the sales promotion system of the first aspect, wherein the management server is configured to: perform the analyzing operation by clustering the integrated action history information for each person to determine a class the target customer belongs to; and generate the purchase prediction information for the target customer based on the determined class.

In this configuration, proper purchase prediction information for the target customer can be generated from the integrated action history information for each person.

A third aspect of the present invention is the sales promotion system of the first aspect, wherein the delivery server delivers a coupon for the product about which the purchase prediction information is generated to the terminal for the target customer.

This configuration can further encourage customers to purchase and drive the customers to make purchase decisions.

A fourth aspect of the present invention is the sales promotion system of the first aspect, wherein the delivery server delivers information which instructs the staff member to serve the target customer, to the terminal for the staff member.

This configuration enables a staff member to serve the target customer so as to effectively encourage the customer into purchases, thereby increasing efficiency of staff members' customer services.

A fifth aspect of the present invention is the sales promotion system of the fourth aspect, wherein the delivery server is configured to: determine a priority level of each customer to be served in the physical store based on real-time store visit information and in-store action information which are acquired from detection information, the detection information being provided by a sensor installed in the physical store; choose a customer to be served based on the priority level; and instruct the staff member to serve the chosen customer.

This configuration can narrow down target customers to be served, thereby increasing efficiency of staff members' customer services.

A sixth aspect of the present invention is the sales promotion system of the first aspect, wherein the delivery server is configured to:

determine a time to deliver the sales promotion information based on real-time store visit information and in-store action information which are acquired from detection information, the detection information being provided by a sensor installed in the physical store.

This configuration enables sales promotion information to be delivered with proper timing.

A seventh aspect of the present invention is the sales promotion system of the first aspect, wherein the delivery server is configured to: acquire the real action history information including past in-store action information which was acquired from detection information, the detection information being provided by a sensor installed in the physical store; and generate the purchase prediction information based on the past in-store action information.

In this configuration, purchase prediction information with high precision can be generated based on past in-store action information; that is, based on information on a person's past actions indicating the person's interest in a product displayed in a physical store.

An eighth aspect of the present invention is the sales promotion system of any one of the fifth, sixth and seventh aspects, wherein the in-store action information includes at least one of information about an event where the target customer makes a stop in front of a store shelf, and information about an event where the target customer performs an in-front-of-shelf action including taking a product from a store shelf.

An event where a person makes a stop in front of a shelf and an event where the person takes in-front-of-shelf actions (such as taking a product from a shell) indicate the person's high interest in the product displayed on the shelf. Accordingly, this configuration makes it possible to properly determine a priority level of a customer to be served, properly determine a time to deliver the sales promotion information, and generate purchase prediction information with high precision.

A ninth aspect of the present invention is the sales promotion system of the first aspect, further comprising a touchpoint terminal, wherein the management server is configured to: deliver the purchase prediction information based on real-time store visit information which is acquired from the touchpoint terminal when the touchpoint terminal is used by a person.

This configuration can generate effective sales promotion information which is based on real-time store visit information with high precision.

A tenth aspect of the present invention is the sales promotion system of the first aspect, further comprising a touchpoint terminal, wherein the management server is configured to: acquire the real action history information including touchpoint information, the touchpoint information indicating that a person uses the touchpoint terminal to view and check information on a specific product.

A touchpoint terminal enables pull provision of information in which information is provided to a user in response to a user's touch interaction with the terminal. Accordingly, in this configuration, the scope of products about which purchase prediction information is generated, can be narrowed down to products of the user's high interest.

An eleventh aspect of the present invention is the sales promotion system of the first aspect, wherein the management server is configured to:

deliver at least one of the integrated action history information or a processed version of the integrated action history information to a device used by at least one business operator selected from a store operator, a marketing adviser, a product manufacturer, and a product ad creator.

This configuration can provide useful information to various business operators.

A twelfth aspect of the present invention is a sales promotion method for causing an information processing system to perform operations to generate and deliver sales promotion information to encourage customers to purchase, the operations comprising: acquiring cyber action history information about persons' past actions on Internet; acquiring real action history information about persons' past actions in a physical store; integrating the cyber action history information and the real action history information to generate integrated action history information for each person; performing an analyzing operation on the integrated action history information to thereby generate purchase prediction information about a product which a target customer is predicted to purchase; and delivering, based on the purchase prediction information, the sales promotion information for the target customer to at least one of a terminal for the target customer and a terminal for a staff member of the physical store.

This configuration enables precise determination of a product which a target customer is predicted to purchase; that is, a product which the customer is highly motivated to purchase at present in the same manner as the first aspect. As a result, it becomes possible to effectively encourage customers to purchase and drive the customers to make purchase decisions, thereby promoting sales of products at physical stores.

Embodiments of the present invention will be described below with reference to the drawings.

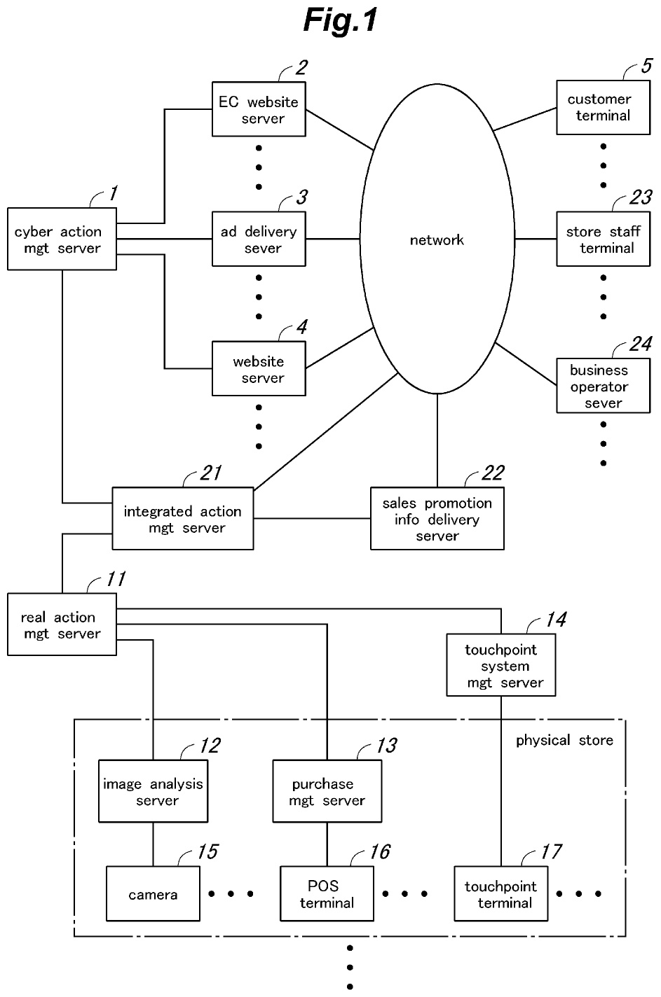

FIG. 1 is a diagram showing a general configuration of a sales promotion system according to an embodiment of the present invention.

The sales promotion system is configured to issue coupons usable at physical stores such as electronics retail stores, and/or to instruct staff members (store staff) to serve customers who come to physical stores, thereby promoting sales of products at the physical stores.

The sales promotion system includes a cyber action management server 1, an EC website server 2, an advertisement delivery server (ad delivery server) 3, a website server 4, and a customer terminal 5.

The cyber action management server 1 is connected to the EC website server 2, the ad delivery server 3, and the website server 4. The EC website server 2, the ad delivery server 3, and the website server 4 can communicate with the customer terminal 5 via the network (Internet).

The EC website server 2 provides an EC website (e-commerce website such as an online shop) through which customers can conduct e-commerce transactions. The ad delivery server 3 delivers ads for various products to the customer terminal 5. The website server 4 provides a website for providing information on various products.

The customer terminal 5 may be a smartphone, a tablet terminal, a PC, or any other suitable device, and is carried by a customer. An application dedicated to the sales promotion system is installed on the customer terminal 5 on the condition that the customer consents to the use of personal information.

The sales promotion system includes a real action management server 11, an image analysis server 12, a purchase management server 13, a touchpoint system management server 14, a camera 15, a POS terminal 16, and a touchpoint terminal 17.

The image analysis server 12 and the purchase management server 13 are installed in a physical store (member store) and are connected to the real action management server 11. The touchpoint system management server 14 is connected to the real action management server 11.

The camera 15 is installed at various places in the store, specifically, at the entrance/exit of the store, around a display shelf, or at any other suitable place. The camera 15 is connected to the image analysis server 12, and images captured by the camera 15 are transmitted to the image analysis server 12.

The POS terminal 16 is installed at various places in the store, specifically, at cashier counters where customers pay for products. The POS terminal 16 is connected to the purchase management server 13, and purchase information entered at the POS terminal 16 is transmitted to the purchase management server 13.

The touchpoint terminal 17 is installed at various places in the store, specifically, near the entrance/exit of the store. In addition, the touchpoint terminal 17 is provided in places that are not in the store, such as in a railway station or other suitable places. The touchpoint terminal 17 is connected to the touchpoint system management server 14.

The touchpoint terminal 17 transmits ID signals to the customer terminal 5 through visible light communications. The customer terminal 5 acquires a URL of a website corresponding to the received ID signal from the touchpoint system management server 14, and accesses the website server 4 using the acquired URL, enabling users to view the website.

The touchpoint terminal 17 may be a dedicated device, a digital signage device which displays ad contents or other information, or an electronic shelf label placed on a display shelf and configured to display a price or other information and have a visible light communication function.

Although, in the present embodiment, the touchpoint terminal 17 transmit desired information such as a URL of a website to the customer terminal 5 by using visible light communications, information transmission methods that can be used include, not limited to visible light communications, use of machine-readable 2D codes and non-contact communications such as NFC (near field communication).

The sales promotion system includes an integrated action management server 21, a sales promotion information delivery server 22, a store staff terminal 23, and a business operator server 24.

The integrated action management server 21 is connected to the cyber action management server 1, the real action management server 11, and the sales promotion information delivery server 22. In addition, the integrated action management server 21 can communicate with the business operator server 24 via the network. The sales promotion information delivery server 22 can communicate with the customer terminal 5 and the store staff terminal 23 via the network.

The store staff terminal 23 may be a smartphone, a tablet terminal, a PC, or any other suitable device, and is carried by a staff member. The business operator server 24 is operated by various business operators.

Although, in the present embodiment, various servers are provided for respective functions, some servers for providing different functions may be integrated into a single integrated server for providing the multiple functions. For example, the integrated action management server 21 and the sales promotion information delivery server 22 may be integrated into a single server for providing the functions of both servers. Furthermore, in the present embodiment, various servers are connected to each other to transmit necessary information therebetween. However, information may be transmitted between the servers using a proper storage medium.

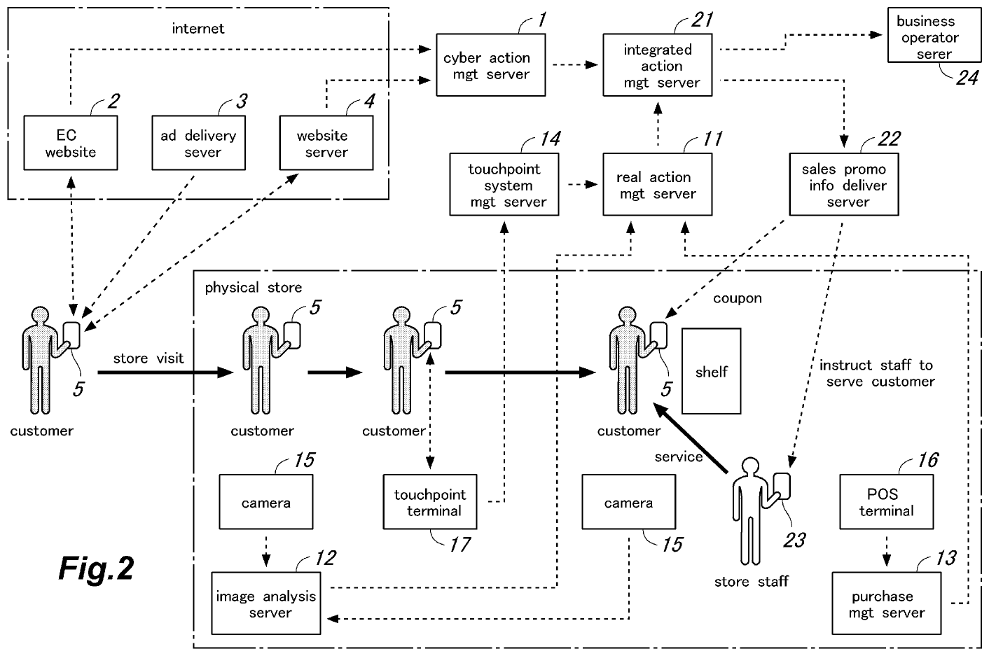

Next, an outline of the sales promotion system will be described. FIG. 2 is an explanatory diagram showing an outline of the sales promotion system.

A customer can access the EC website server 2 from the customer terminal 5, views the EC website, and conduct e-commerce transactions. Furthermore, referring to an ad delivered from the ad delivery server 3 or a search result from an Internet search service, a customer can access the website server 4 and view a website provided from that server by using the customer terminal 5.

Customers sometimes come to a physical store only to check real products of their interest. In this case, a camera 15 installed at the entrance of the store captures a picture image(s) of a customer. In addition, the customer performs a touch interaction with the touchpoint terminal 17 provided near the entrance of the store in order to obtain store-entry coupon points.

Next, when the customer browses in the store to find a touchpoint terminal 17 associated with a product of interest, the customer can perform a touch interaction with the touchpoint terminal 17, and upon receiving a URL of a website delivered in response to the touch interaction, the customer can view the website of the received URL.

Also, when the customer browses in the store to come in front of a shelf which displays a product of interest, the customer can make a stop there and perform in-front-of-shelf actions (such as taking a product from the shelf, returning a product to the shelf, and checking a product for selection). When such an event occurs in front of a shelf, a camera 15 provided near the shelf captures a picture image(s) of the customer.

Next, when the customer decides to purchase the product, the customer pays for the product at a cashier counter. When the payment is made, a store staff member enters information on the product to the POS terminal 16.

The cyber action management server 1 collects information on website browsing and purchases of products from the EC website server 2 and the website server 4, and accumulates the collected information as cyber action history information.

The image analysis server 12 performs face authentication based on picture images captured by the camera 15 at the entrance of the store to thereby detect a store visit of the customer, and generates real-time store visit information. Therefore, the camera 15 at the entrance of the store functions as a sensor for detecting visits of customers. Furthermore, the image analysis server 12 performs an action analysis based on the picture image captured by the camera 15 in the sales floor to detect customers' in-front-of-shelf actions (such as taking a product from the shelf, returning a product to the shelf, and checking a product for selection), thereby generating in-store action information.

The purchase management server 13 collects customers' purchase information from the POS terminal 16.

The touchpoint system management server 14 collects information on each user's use of the touchpoint terminal 17 from the touchpoint terminal 17. In particular, the touchpoint system management server 14 detects a customer's visit by a customer's touch interaction with the touchpoint terminal 17 near the store entrance and generates real-time store visit information. Thus, the touchpoint terminal 17 near the entrance of the store functions as a sensor for detecting visits of customers.

The real action management server 11 collects information accumulated in the image analysis server 12, the purchase management server 13, and the touchpoint system management server 14, integrates the collected information for each person, and accumulates the integrated information as real action history information for each person.

The integrated action management server 21 collects cyber action history information from the cyber action management server 1, collects real action history information from the real action management server 11 and integrates the collected information for each person. In this way, the integrated action management server 21 can manage information records of past actions on the Internet and past actions in an actual store for each person.

The integrated action management server 21 analyzes the integrated action history information for each person to generate purchase prediction information about a product which a target customer is predicted to purchase.

The integrated action management server 21 performs a processing operation (such as statistical processing) on the integrated action history information to generate information for business operators, and delivers the information for business operators to the business operator server 24. In this case, examples of business operators to which the information for business operators is delivered include a store operator, a marketing adviser, a product manufacturer, and a product ad creator.

The sales promotion information delivery server 22 collects purchase prediction information from the integrated action management server 21, and delivers, based on the purchase prediction information, the collected sales promotion information which can encourages customers to purchase, to the customer terminal 5 and the store staff terminal 23. In the present embodiment, the sales promotion information delivery server 22 delivers a coupon to the customer terminal 5 as sales promotion information for the customer. When a staff member needs to serve a customer, the sales promotion information delivery server 22 also delivers an instruction to the store staff terminal 23, instructing the staff member to serve a customer.

The system may be configured such that, when the provision of services to a customer is completed, a store staff member enters information indicating whether or not the customer has been served (customer service provision information) into the store staff terminal 23, and registers the customer service provision information in a database such as the integrated action management server 21. This enables evaluation of the effect of staffs services by comparing between occurrence of customer's purchase in the case with staffs services and that in the case without staffs services.

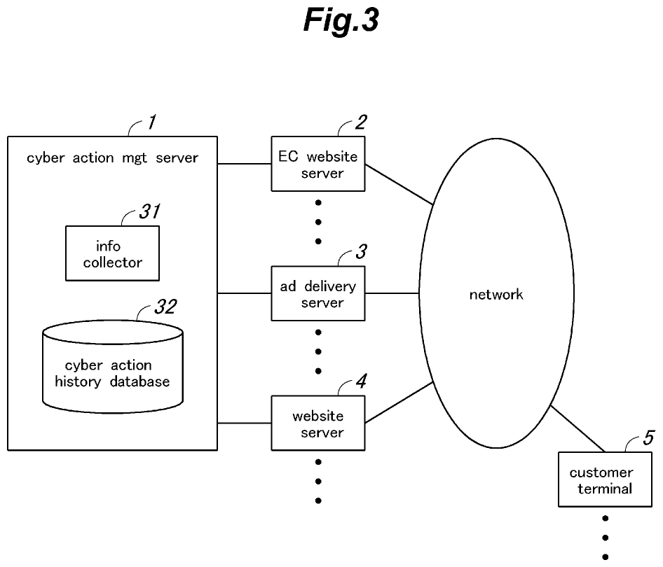

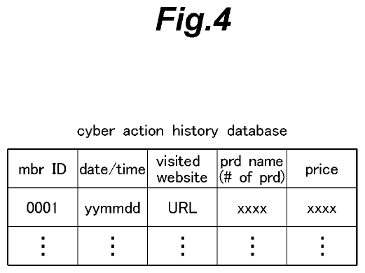

Next, the cyber action management server 1 will be described. FIG. 3 is a functional block diagram showing the cyber action management server 1. FIG. 4 is an explanatory diagram showing an example of records registered in a cyber action history database 32.

As shown in FIG. 3, the cyber action management server 1 includes an information collector 31 and the cyber action history database 32. Each unit of the cyber action management server 1 is implemented by a processor (controller) executing a program stored in a storage or a memory.

The information collector 31 collects information records for each customer from the EC website server 2, the information records including browsing history information and purchase history information associated with an EC website, and registers the collected information in the cyber action history database as cyber action history information. The information collector 31 collects browsing history information for each customer on the website from the website server 4, and registers the collected information in the cyber action history database as cyber action history information.

The cyber action history database 32 manages cyber action history information for each person, and as shown in FIG. 4, contains registered data records for each person such as member ID, date and time, websites browsed, and information on purchased products (product name (product number), price). If a person only browses a website and has not purchased any product, no information on purchased products is registered.

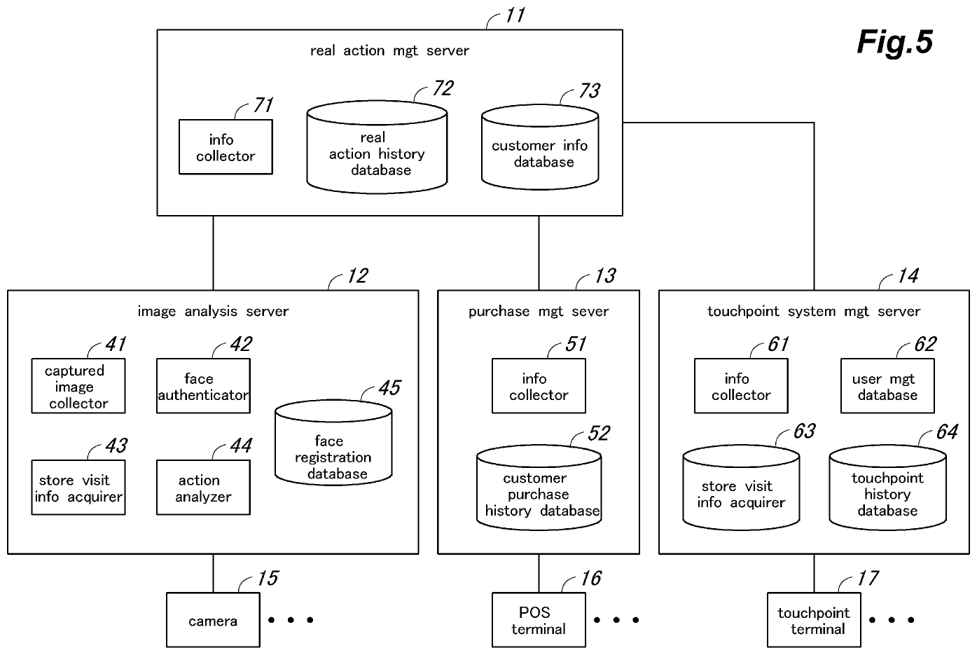

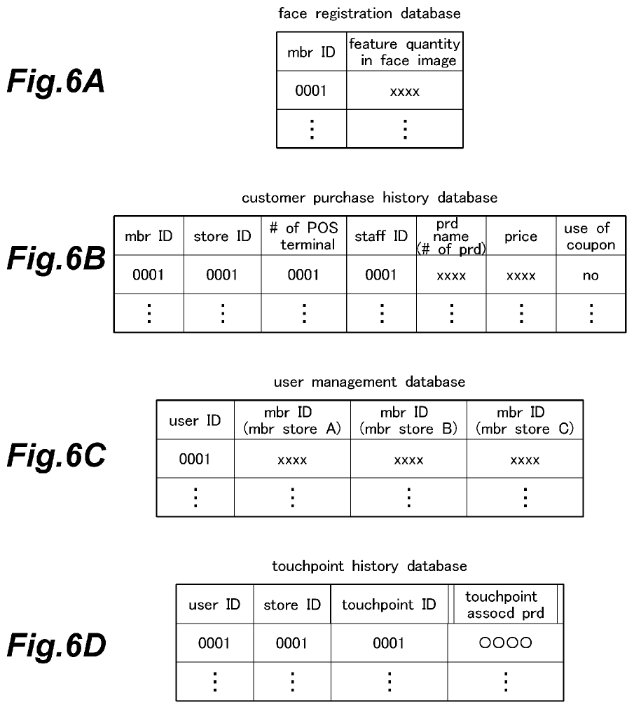

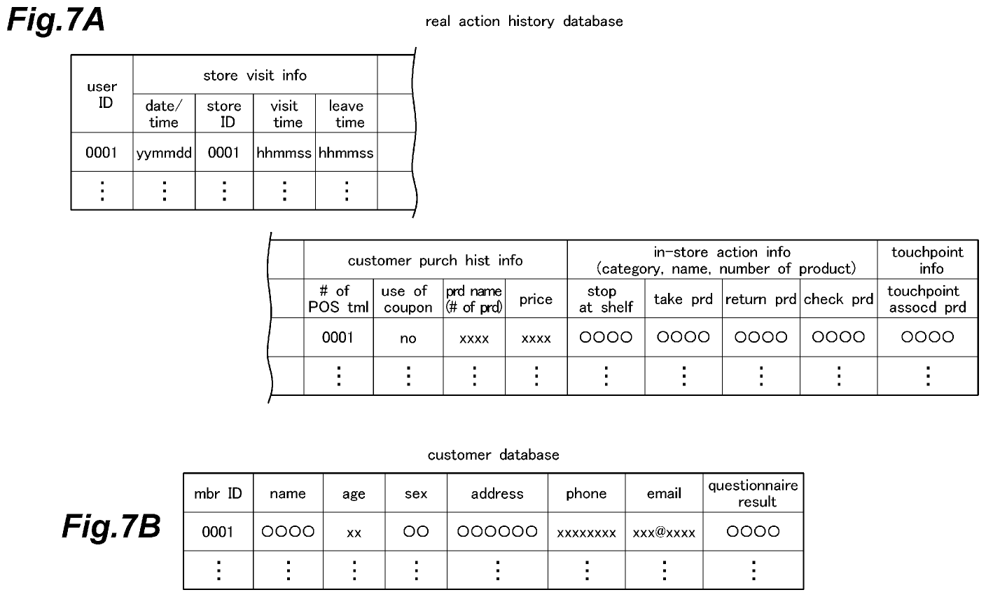

Next, a real action management server 11, an image analysis server 12, a purchase management server 13, and a touchpoint system management server 14 will be described. FIG. 5 is a functional block diagram showing the respective servers. FIG. 6 is an explanatory diagram showing examples of records registered in a face registration database 45, a customer purchase history database 52, a user management database 63, and a touchpoint history database 64. FIG. 7 is an explanatory diagram showing examples of records registered in a real action history database 72 and a customer information database 73.

As shown in FIG. 5, the image analysis server 12 includes a captured image collector 41, a face authenticator 42, a store visit information acquirer 43, an action analyzer 44, and a face registration database 45. Each unit of the image analysis server 12 is implemented by a processor (controller) executing a program stored in the memory or storage.

The captured image collector 41 collects captured picture images provided from the camera 15.

The face authenticator 42 performs face authentication (personal authentication) on captured picture images provided from the camera 15. Specifically, the face authenticator 42 extracts feature quantities from face images detected from captured picture images provided from the camera 15, compares the feature quantities of the face image of a person with feature quantities of a pre-registered face image of each customer, and identifies the person appearing in the captured picture image. The face authenticator 42 acquires the member ID of a customer who has visited the store through the face authentication, and registers the member ID and the extracted feature quantities (facial feature information) in the face registration database 45.

Based on an authentication result provided by the face authenticator 42, the store visit information acquirer 43 detects a customer who has visited the store, and acquires information (store visit information) about the customer. In the present embodiment, the store visit information acquirer 43 acquires date and time, a store ID, and store visit time as store visit information for each customer. Moreover, the store visit information acquirer 43 detects a customer who leaves the store based on an authentication result provided by the face authenticator 42, and acquires store leave time.

The action analyzer 44 detects actions of persons in picture images captured by the camera 15 and acquires in-store action information on actions of customers in the store. Specifically, the action analyzer 44 detects an event where a customer makes a stop in front of a shelf, and also detects an event where the customer performs actions such as taking a product from the shelf, returning a product to the shelf, and checking a product for selection. In addition, the action analyzer 44 acquires, based on the location where the customer makes a stop and the positon of the customer's hand, product information (such as a product category, a product name, and a product number) related to a product for which the customer's action occurs; that is, a product of the customer's interest.

The action analyzer 44 may be configured to detect customer's actions including looking at a product displayed in the store or looking at an advertisement placed in the store. The action analyzer 44 may also be configured to measure a customer's stop time in front of a shelf based on a detection result indicating an event where the customer makes a stop in front of the shelf. The action analyzer 44 may also be configured to measure how many times a customer takes a product from a shelf based on a detection result indicating that the customer takes the product in front of the shelf. The action analyzer 44 may also be configured to measure how many times a customer leaves the store without purchasing any product. Moreover, the action analyzer 44 may be configured to acquire a customer's movement path information by tracking the customer. Furthermore, the action analyzer 44 may be configured to determine a customer's level of willingness to purchase by analyzing stop times in front of the shelves and movement paths in the store to identify a product which the customer has showed high motivation to purchase.

In the present embodiment, the action analyzer 44 analyzes picture images captured by the camera 15 to acquire store visit information and in-store action information. However, in other embodiment, a sensor other than the camera 15 may be provided in the store, and the action analyzer 44 may detect, based on detection information provided by the sensor, an event where a customer performs an action which shows the customer's interest in a product displayed in a physical store.

The face registration database 45 manages a feature quantity in a face image for each customer. As shown in FIG. 6A, the face registration database 45 stores registered data records for each person such as a member ID and feature quantity.

As shown in FIG. 5, the purchase management server 13 includes an information collector 51 and the customer purchase history database 52. Each unit of the purchase management server 13 is implemented by a processor (controller) executing a program stored in a storage or a memory.

The information collector 51 collects purchase information for each customer from the POS terminal 16, and registers the collected information in the customer purchase history database 52 as customer purchase history information.

The customer purchase history database 52 manages customer purchase history information for each person, and as shown in FIG. 6B, contains registered data records for each purchase of each person such as member ID, a store ID, the number of a POS terminal 16, a store staff ID, information on purchased products (product name (product number), price), and information on use of a coupon (whether or not a coupon is used).

As shown in FIG. 5, the touchpoint system management server 14 includes an information collector 61, a store visit information acquirer 62, the user management database 63, and the touchpoint history database 64. Each unit of the touchpoint system management server 14 is implemented by a processor (controller) executing a program stored in a storage or a memory.

The information collector 61 collects information provided by a user's touch interaction with a touchpoint terminal 17 (touchpoint information) from the touchpoint terminal 17, and registers the collected touchpoint information in the touchpoint history database 64 as touchpoint history information.

Based on touchpoint information collected from the touchpoint terminal 17 located near the entrance of the store, the store visit information acquirer 62 detects a customer who has visited the store, and acquires information (store visit information) about the customer. In the present embodiment, the store visit information acquirer 62 may acquire date and time, a store ID, and store visit time as store visit information for each customer.

The user management database 63 manages information on users of the touchpoint system. As shown in FIG. 6C, the user management database 63 stores registered data records for each person including a user ID for the touchpoint system and each member ID for a corresponding store.

The touchpoint history database 64 manages customer touchpoint history information for each person, and as shown in FIG. 6D, contains registered data records for each purchase of each person such as a user ID for the touchpoint system, a store ID, a terminal ID for a touchpoint terminal 17, and a product associated with the touchpoint terminal 17.

As shown in FIG. 5, the real action management server 11 includes an information collector 71, a real action history database 72, and a customer information database 73. Each unit of the real action management server 11 is implemented by a processor (controller) executing a program stored in a storage or a memory.

The information collector 71 collects store visit information and in-store action information from the image analysis server 12, and registers the store visit information and the in-store action information in the real action history database 72. The information collector 71 also collects store customer purchase history information (see FIG. 6B) from the purchase management server 13, and registers the customer purchase history information in the real action history database 72. The information collector 71 also collects touchpoint history information (see FIG. 6D) from the touchpoint system management server 14, and registers the touchpoint history information in the real action history database 72.

The real action management server 11 may be configured to acquire user management information (see FIG. 6C) from the touchpoint system management server 14, and, based on the user management information, associate a member ID with a corresponding user ID in the touchpoint history information for each person.

The real action history database 72 manages real action history information for each customer. As shown in FIG. 7A, the real action history database 72 stores registered data records for each person such as member ID, store visit information, customer purchase history information, in-store action information, and touchpoint information. The store visit information for each person includes date and time, a store ID, store visit time, and store leave time. The customer purchase history information for each purchase of each person includes the number of a POS terminal 16, information on use of a coupon (whether or not a coupon is used), and information on the purchased product (product name (product number), price). The in-store action information for each person includes information on products for which the person's actions occur, the person's actions including making a stop in front of a store shelf, taking a product from a store shelf, returning a product to the shelf, and checking a product for selection. The touchpoint information for each purchase includes information on a product associated with a touchpoint terminal 17.

The customer information database 73 manages customer information. As shown in FIG. 7B, the customer information database 73 stores registered data records of each customer such as member ID, name, age, gender, address, telephone number, e-mail address, and information on questionnaire results.

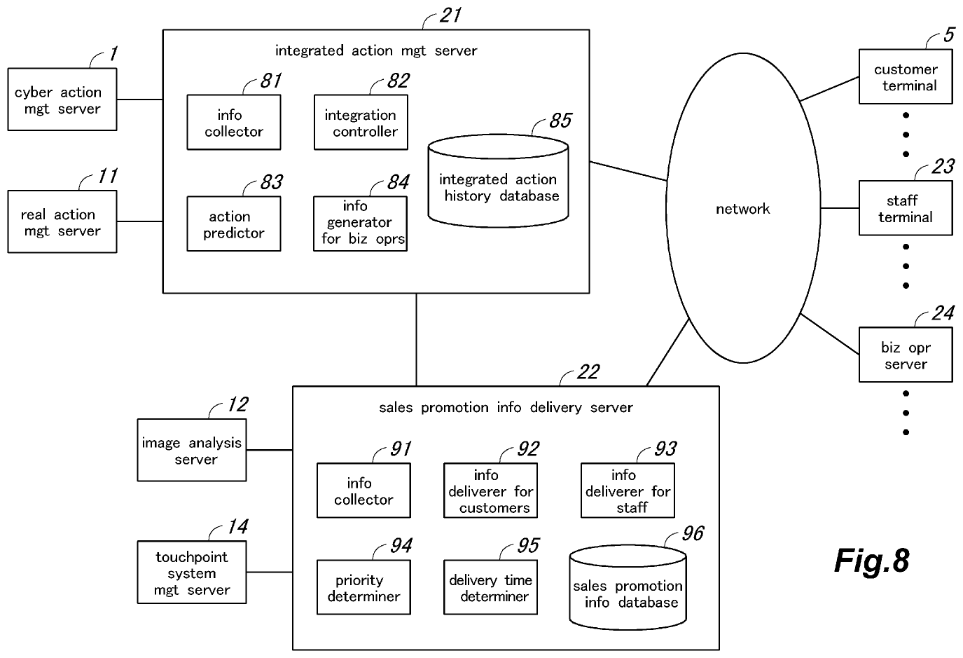

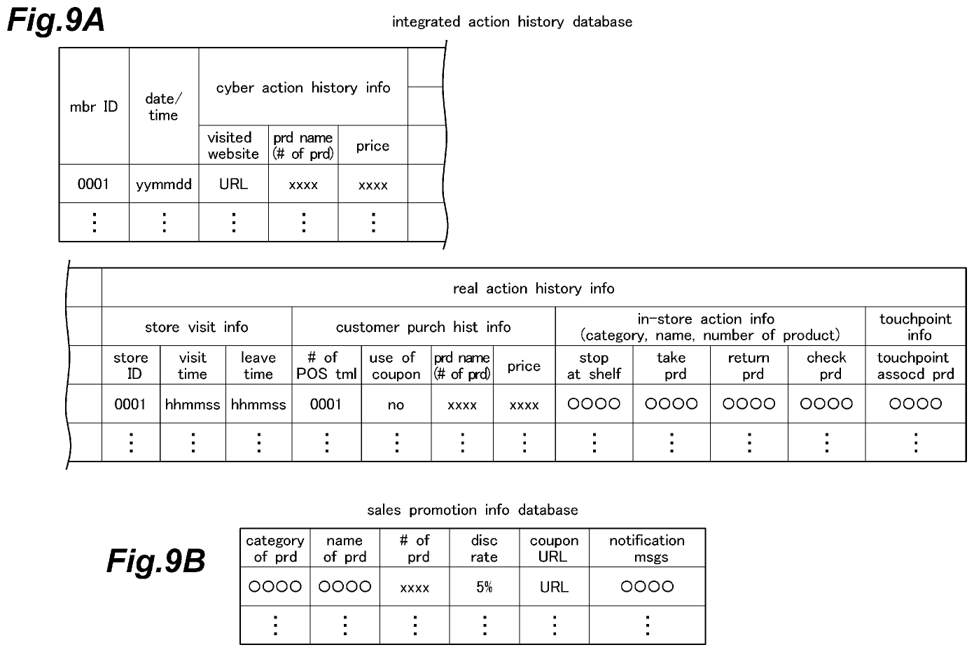

Next, an integrated action management server 21 and a sales promotion information delivery server 22 will be described. FIG. 8 is a functional block diagram showing the integrated action management server 21 and the sales promotion information delivery server 22. FIG. 9 is an explanatory diagram showing examples of records registered in an integrated action history database 85 and a sales promotion information database 96.

As shown in FIG. 8, the integrated action management server 21 includes an information collector 81, an integration controller 82, an action predictor 83, an information generator 84 for business operators, and an integrated action history database 85. Each unit of the integrated action management server 21 is implemented by a processor (controller) executing a program stored in a storage or a memory.

The information collector 81 collects cyber action history information (see FIG. 4) from the cyber action management server 1. The information collector 81 also collects real action history information (see FIG. 7A) from the real action management server 11.

The integration controller 82 integrates cyber action history information and real action history information for each person, generates integrated action history information for each person, and registers the integrated action history information in the integrated action history database 85. In generating integrated action history information, provided that information records are those of the same person, the integration controller 82 associates the cyber action history information with the real action history information.

The integration controller 82 may make an association between cyber action history information and real action history information for a person based on a personal ID which a customer uses in both a website on the Internet and a physical store. For example, in cases where a customer utilizes a point service system in which points are given according to purchase prices in both a website on the Internet and a physical store, the integration controller 82 may make an association between two sets of information records for a customer based on the member's ID used in the point service system. The integration controller 82 may be configured to acquire a terminal ID from the customer terminal 5 when a customer browses websites or performs a touch interaction with the touchpoint terminal 17, and make an association between two sets of information records based on the terminal ID.

The action predictor 83 analyzes integrated action history information for each person registered in the integrated action history database 85, and generates purchase prediction information about a product(s) which a target customer is predicted to purchase.

The action predictor 83 may make an analysis and a prediction through a model created by using machine learning. In this case, the action predictor 83 uses integrated action history information records of a target customer as input information to the model created by using machine learning, to thereby provide purchase prediction information for the customer as output information.

The information generator 84 for business operators performs a processing operation (such as statistical processing) on integrated action history information for each person registered in the integrated action history database 85, to generate information for business operators. The information for business operators is delivered from the integrated action management server 21 to the business operator server 24. In other cases, the integrated action history information may be delivered to the business operator server 24 without being subject to any processing operation.

In the case of use of such a processing operation, integrated action history information for each person may be processed based on each person's attributes (such as age, gender) to provide information associated with any of the person's attributes or information on how a person's level of interest in a product is correlated with any of the persons attributes. This enables the system to provide business operators with useful information therefor.

The integrated action history database 85 manages integrated action history information for each person. As shown in FIG. 9A, the integrated action history database 85 stores registered data records of each person such as member ID, date and time, cyber action history information, and real action history information. Items of the cyber action history information are the same as those in the cyber action history database 32 (see FIG. 4). Items of the real action history information are the same as those in the real action history database 72 (see FIG. 7A).

As shown in FIG. 8, the sales promotion information delivery server 22 includes an information collector 91, an information deliverer 92 for customers, an information deliverer 93 for store staff, a priority determiner 94, a delivery time determiner 95, and a sales promotion information database 96. Each unit of the sales promotion information delivery server 22 is implemented by a processor (controller) executing a program stored in a storage or a memory.

The information collector 91 collects purchase prediction information from the integrated action management server 21. The information collector 91 also collects real-time store visit information and in-store action information from the image analysis server 12. The store visit information and the in-store action information are acquired by analyzing picture images captured by the camera 15. The information collector 91 also collects real-time store visit information from the touchpoint system management server 14. The store visit information is provided when a user performs a touch interaction with a touchpoint terminal 17 disposed in the store.

Based on the purchase prediction information provided from the integrated action management server 21, the customer information deliverer 92 delivers sales promotion information for customers to customer terminals 5 carried by customers in a physical store. In the present embodiment, the customer information deliverer 92 delivers coupons (such as discount coupons, complimentary tickets, and free service tickets) to the customer terminals 5 as the sales promotion information for customers, where the coupons delivered to a customer are associated with one or more products about which the purchase prediction information is generated; that is, one or more products which the customer is predicted to purchase (those the customer is likely to have a high motivation to purchase).

The customer information deliverer 92 may be configured to deliver a message with a recommendation of the product to a customer (product recommendation information) to the customer terminal 5 separated from or together with a coupon.

In addition, coupons to be delivered are preferably a coupon offering a limited user discount rate for a target customer or an in-store coupon offering limited time discount, such as one which is available today only and can be used only in the store a customer is currently visiting. As a result, it becomes possible to effectively encourage customers to purchase and drive the customers to make purchase decisions at the store they are currently visiting.

Instead of providing coupons, the customer information deliverer 92 may offer a target customer a discounted price of a recommended product for the target customer. Specifically, the customer information deliverer 92 may be configured to deliver a discount offer message to a customer terminal 5 in a similar manner to delivery of coupons, or in other embodiments, the customer information deliverer 92 may be configured to deliver a discounted price of a recommended product to electronic point-of-purchase displays, signage or any other indicator device (not shown) in front of or near the target customer to thereby cause them to display it, in response to the target customer's location information analyzed by the image analysis server 12. Alternatively, the customer information deliverer 92 may cause an electronic shelf label for a recommended product to display a discounted price of the product for the target customer, thereby offering the discounted price only to that customer. In this case, since the discount price of a certain product is different for each customer, it is necessary to connect each discounted price to a corresponding customer for which the price is presented. In order to make this connection in practice, for example, the customer terminal 5 may be configured to include application software which enables a user to purchase and make payment when a discounted price is presented to the user, or the customer terminal 5 may be configured to display a discounted price of a product for a user and enable the user to interact with the customer terminal 5 so as to indicate the user's intention to purchase the produce at the discounted price (the user's agreement on the price), followed by making payment at a checkout counter. Moreover, in order to enable the payment at a checkout counter, for example, the customer terminal 5 may be configured to transmit a member ID of the customer to a payment system of a POS checkout counter when the user interacts with the customer terminal 5 to indicate the intention to purchase, and then, at the POS checkout counter, after acquiring the member ID of the customer from the customer terminal 5, the payment system checks the acquired member ID against the member ID which has already received, so as to enable the user to make payment at the agreed discounted price. A discounted price may be determined in consideration of a level of the customer's demand for a product estimated from the customer's past action history information, as well as an amount of stock, an amount of purchase, and an amount of production amount, of the product and other factors related thereto. (For example, when a level of the customer's demand is high and an amount of stock is decreased, a discount rate is determined to be lower, while when a level of the customer's demand is low and an amount of stock is increased, a discount rate is determined to be higher.)

The information deliverer 93 for store staff delivers sales promotion information for store staff to the store staff terminal 23 based on the purchase prediction information acquired from the integrated action management server 21. In the present embodiment, the information deliverer 93 for store staff delivers instruction information to the store staff terminal 23 as sales promotion information for store staff, the instruction information instructing store staff to serve the target customer.

The sales promotion information for store staff may include product information which notifies store staff of products a target customer has shown high motivation to purchase, such as products which the customer has viewed on a website in the past. The information deliverer 93 for store staff may be configured to acquire the current location of a target customer based on a person identification result provided by face authentication and a target customer's movement path information, and notify store staff of the current location of the target customer. In this case, the store staff terminal 23 is preferably configured to display a screen showing the customer's location on the area map of the store.

The information deliverer 93 for store staff may be configured to determine, based on purchase prediction information, a suitable customer service method which is likely to encourage a target customer to purchase, and notify store staff of the determined customer service method along with instructing the store staff to serve the target customer.

The priority determiner 94 determines a priority level of each customer to be served in the store, based on real-time store visit information and in-store action information acquired by the information collector 91. Specifically, the priority determiner 94 determines a higher priority level when a product for which the customer's actions occur (e.g. a product which the customer has taken up from the shelf) is highly correlated with products about which purchase prediction information is generated. The sales promotion information delivery server 22 chooses a customer to be served with a high priority level based on a determination result provided by the priority determiner 94, and delivers sales promotion information indicating the chosen customer to be served to the store staff terminal 23.

In other embodiment, the action analyzer 44 may determine each customer's level of motivation to purchase based on in-store action information or other information, and the sales promotion information delivery server 22 may choose a customer to be served based on the determined customer's levels of motivation.

The delivery time determiner 95 performs delivery time determination to determine the time to deliver sales promotion information, based on real-time store visit information and in-store action information acquired by the information collector 91. By performing the delivery time determination based on real-time store visit information, the sales promotion information delivery server 22 can deliver sales promotion information while the customer is present in the physical store. In addition, the real-time in-store action information includes information on an event where a customer performs actions, such as making a stop in front of a shelf and taking a product from the shelf, which show the customer's interest in a product displayed in a physical store. By performing the delivery time determination based on the information on a customer's actions, the sales promotion information delivery server 22 can deliver sales promotion information (coupons or instructions to staff to offer customer service) during a customer taking an action which shows the customer's interest in a product.

Although, in the present embodiment, the sales promotion information delivery server 22 delivers the sales promotion information to a customer terminal 5 carried by a customer in the physical store, the sales promotion information delivery server 22 may be configured to deliver sales promotion information (coupons) to the customer terminal 5 when the customer enters an area around the physical store; that is, while the customer is moving toward the physical store. In this case, the system may be configured to acquire location information including the current location of the customer terminal 5 by using a positioning system such as GPS. Furthermore, the sales promotion information delivery server 22 may be configured to deliver sales promotion information to a customer terminal 5 when the customer uses a touchpoint terminal 17.

The sales promotion information database 96 manages sales promotion information delivered to the customer terminal 5 and the store staff terminal 23. As shown in FIG. 9B, the sales promotion information database 96 contains registered data records such as product information (product category, product name, product number), information about coupons (discount rate, URL of websites showing the barcode of a coupon), and information about notification messages included in the sales promotion information. The sales promotion information database 96 may contain information about customers who have been determined to be served by store staff.

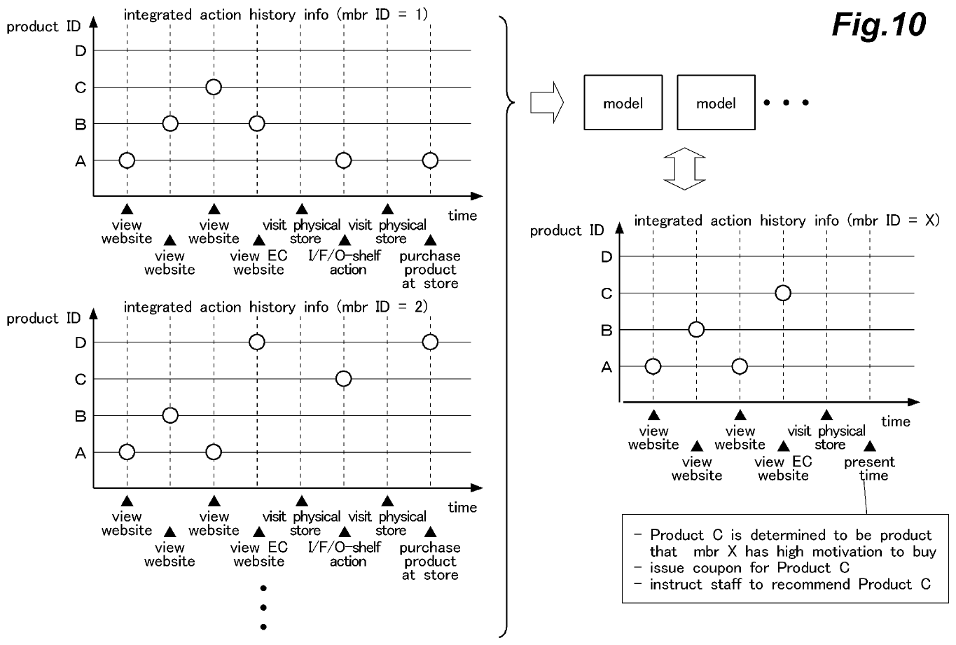

Next, an outline of operations performed by an action predictor 83 of the integrated action management server 21 will be described. FIG. 10 is an explanatory diagram showing an outline of operations performed by the action predictor 83.

The action predictor 83 of the integrated action management server 21 analyzes integrated action history information for each person stored in the integrated action history database 85, and generates purchase prediction information as to which product a target customer is predicted to purchase. The integrated action history information contains information on products for which the customer's actions occur, which are products of the person's high interest. The analysis of the integrated action history information enables identification of a product of the person's high interest; that is, a product which the person is highly motivated to purchase.

Specifically, first, the action predictor 83 performs a sort operation on integrated action history information for each person in the integrated action history database 85 to put records of the person's actions in order by date and time, thereby making it possible to check how the person's actions have been taken place with time (person's action patterns).

Next, the action predictor 83 performs a clustering operation on the integrated action history information for each person; that is, classifies the integrated action history information for each person into a plurality of classes (groups) to create models which represent standard action patterns for the respective classes.

Next, upon detecting a store visit of a customer, the action predictor 83 acquires integrated action history information for the customer, and determines which class the action pattern the integrated action history information represents belongs to. Specifically, the action predictor 83 compares the action pattern represented by the integrated action history information with an action pattern represented by the model of each class, to thereby choose a class for which an action pattern represented by the model of the class is highly correlated with the action pattern represented by the integrated action history information.

Next, the action predictor 83 acquires information on products which have been purchased by the target customer, and based on the acquired information, generates purchase prediction information about a product(s) which the target customer is predicted to purchase.

In the example shown in FIG. 10, actions performed by the person are indicated in chronological order on the horizontal axis, where the actions include viewing websites, browsing EC websites, visiting a physical store, and in-front-of-shelf actions in the stores (such as taking a product form a shelf), whereas IDs of products which represent product categories (A, B, C, D . . . ) are indicated on the vertical axis. This makes it possible to check what actions have been performed by the target customer with time in the past.

Next, the action predictor 83 compares the action pattern of a target member (ID=X) with an action pattern of the model of each class to thereby determine which class the member (ID=X) belongs to. Then, based on the purchased products of the class which the target member (ID=X) belongs to, the action predictor 83 predicts a product the target member (ID=X) is likely to purchase next; that is a product which he target member (ID=X) has shown high motivation to purchase.

In this way, if when the action predictor 83 predicts, for example, Product C as a product which the target member (ID=X) shows has shown high motivation to purchase, the sales promotion system issues a coupon for the Product C, and also instructs store staff to recommend the Product C to the customer when serving the customer.

Specific embodiments of the present invention are described herein for illustrative purposes. However, the present invention is not limited to those specific embodiments, and various changes, substitutions, additions, and omissions may be made for elements of the embodiments without departing from the scope of the invention. In addition, elements and features of the different embodiments may be combined with each other to yield an embodiment which is within the scope of the present invention.

### INDUSTRIAL APPLICABILITY

A sales promotion system and a sales promotion method according to the present invention achieve an effect of making it possible to precisely determine products which a target customer is predicted to purchase, and implement on site measures to encourage the customer to purchase the product, thereby promoting sales of products at a physical store, and are useful as a sales promotion system and a sales promotion method for generating and delivering sales promotion information to encourage customers to purchase.

### GLOSSARY

1 cyber action management server
2 EC website server
3 ad delivery server
4 website server
5 customer terminal
11 real action management server
12 image analysis server
13 purchase management server
14 touchpoint system management server
15 camera
16 terminal
17 touchpoint terminal
21 integrated action management server
22 sales promotion information delivery server
23 store staff terminal
24 business operator server

1. A sales promotion system for generating and delivering sales promotion information to encourage customers to purchase, comprising:
a management server; and
a delivery server;
wherein the management server is configured to:
acquire cyber action history information about persons' past actions on Internet;
acquire real action history information about persons' past actions in a physical store;
integrate the cyber action history information and the real action history information to generate integrated action history information for each person; and
perform an analyzing operation on the integrated action history information to thereby generate purchase prediction information about a product which a target customer is predicted to purchase, and
wherein the delivery server is configured to:
deliver, based on the purchase prediction information, the sales promotion information for the target customer to at least one of a terminal for the target customer and a terminal for a staff member of the physical store.

2. The sales promotion system according to claim 1, wherein the management server is configured to:
perform the analyzing operation by clustering the integrated action history information for each person to determine a class the target customer belongs to; and
generate the purchase prediction information for the target customer based on the determined class.

3. The sales promotion system according to claim 1, wherein the delivery server delivers a coupon for the product about which the purchase prediction information is generated to the terminal for the target customer.

4. The sales promotion system according to claim 1, wherein the delivery server delivers information which instructs the staff member to serve the target customer, to the terminal for the staff member.

5. The sales promotion system according to claim 4, wherein the delivery server is configured to:
determine a priority level of each customer to be served in the physical store based on real-time store visit information and in-store action information which are acquired from detection information, the detection information being provided by a sensor installed in the physical store;
choose a customer to be served based on the priority level; and
instruct the staff member to serve the chosen customer.

6. The sales promotion system according to claim 1, wherein the delivery server is configured to:
determine a time to deliver the sales promotion information based on real-time store visit information and in-store action information which are acquired from detection information, the detection information being provided by a sensor installed in the physical store.

7. The sales promotion system according to claim 1, wherein the DLS is configured to:
acquire the real action history information including past in-store action information which was acquired from detection information, the detection information being provided by a sensor installed in the physical store; and
generate the purchase prediction information based on the past in-store action information.

8. The sales promotion system according to claim 5, wherein the in-store action information includes at least one of information about an event where the target customer makes a stop in front of a store shelf, and information about an event where the target customer performs an in-front-of-shelf action including taking a product from a store shelf.

9. The sales promotion system according to claim 1, further comprising a touchpoint terminal,
wherein the management server is configured to:
deliver the purchase prediction information based on real-time store visit information which is acquired from the touchpoint terminal when the touchpoint terminal is used by a person.

10. The sales promotion system according to claim 1, further comprising a touchpoint terminal,
wherein the management server is configured to:
acquire the real action history information including touchpoint information, the touchpoint information indicating that a person uses the touchpoint terminal to view and check information on a specific product.

11. The sales promotion system according to claim 1, wherein the management server is configured to:
deliver at least one of the integrated action history information or a processed version of the integrated action history information to a device used by at least one business operator selected from a store operator, a marketing adviser, a product manufacturer, and a product ad creator.

12. A sales promotion method for causing an information processing system to perform operations to generate and deliver sales promotion information to encourage customers to purchase, the operations comprising:
acquiring cyber action history information about persons' past actions on Internet;
acquiring real action history information about persons' past actions in a physical store;
integrating the cyber action history information and the real action history information to generate integrated action history information for each person;
performing an analyzing operation on the integrated action history information to thereby generate purchase prediction information about a product which a target customer is predicted to purchase; and
delivering, based on the purchase prediction information, the sales promotion information for the target customer to at least one of a terminal for the target customer and a terminal for a staff member of the physical store.
